(19) United States
(12) Patent Application Publication
(10) Pub. No.: US 2025/0151907 A1
(43) Pub. Date: May 15, 2025

(54) CHAIR FRAME AND CHAIR

(71) Applicant: HAINING HELI MACHINERY& TECHNOLOGY CO., LTD., Jiaxing (CN)

(72) Inventors: Xiqi SUN, Jiaxing (CN); Qiu XU, Jiaxing (CN); Mengjie LI, Jiaxing (CN); Junjun DAI, Jiaxing (CN)

(21) Appl. No.: 18/913,846

(22) Filed: Oct. 11, 2024

(30) Foreign Application Priority Data
Nov. 13, 2023 (CN) 202323078758.0

(51) Int. Cl. A47C 1/0355; A61G 5/14

(52) U.S. Cl. CPC A47C 1/0355; A61G 5/14

(57) ABSTRACT

A chair frame and a chair. The chair frame includes a pedestal, a lifting assembly, a driving assembly, a bearing framework and an extending assembly. The first restricting members are fixed to the bearing framework. The driving assembly includes a first push rod, a synchronizing rod and two transmission plates. One end of the first push rod is pivotally connected to the pedestal, the other end of the first push rod is pivotally connected to the synchronizing rod, and both ends of the synchronizing rod are fixed to the transmission plate. The transmission plate is connected to a side of the bearing framework. The transmission plate can rotate relative to the framework, and the transmission plate can rotate until the transmission plate abuts against the first restricting member. The lifting assembly is connected between the bearing framework and the pedestal, and the extending assembly is connected to the bearing framework.

### CROSS-REFERENCE TO RELATED APPLICATION

This application claims priority to Chinese patent application No. 202323078758.0, filed on Nov. 13, 2023, and titled “CHAIR FRAME OF CHAIR FOR ELDERLY AND CHAIR FOR ELDERLY”, the content of which is hereby incorporated by reference in its entirety.

### TECHNICAL FIELD

The present disclosure relates to the field of chair, in particular, to a chair frame and a chair.

### BACKGROUND

Chairs for seniors are mechanical devices designed for the helping the elderly to adjust their sitting posture and assist in standing. However, the chairs for seniors in the related art have complex structures and many components, which in turn lead to more cumbersome installation and high production costs.

### SUMMARY

A chair, which has less components and low cost and is easy to assembly, is provided in the present disclosure on the basis of embodiments of the present disclosure.

A chair frame is provided in the present disclosure. The chair frame includes a pedestal, a lifting assembly, a driving assembly, a bearing framework and an extending assembly; wherein first restricting members are fixed to both sides of the bearing framework; the driving assembly includes a first push rod, a synchronizing rod and two transmission plates, one end of the first push rod is pivotally connected to the pedestal, the other end of the first push rod is pivotally connected to the synchronizing rod, both ends of the synchronizing rod are fixed to one of the two transmission plates, respectively, each of the two transmission plates is rotatably connected to a side of the bearing framework, respectively, and the two transmission plates are capable of rotating until to abut against a corresponding first restricting member, and the lifting assembly is connected between the bearing framework and the pedestal, and the extending assembly is connected to the bearing framework. When each of the two transmission plates abuts against the corresponding first restricting member, the first push rod is capable of retracting or extending to drive the lifting assembly to retract or extend, and when each of the two transmission plates separates from the corresponding first restricting member, the first push rod is capable of retracting or extending to drive the extending assembly to retract or extend.

In some embodiments, the bearing framework includes two sets of bearing assembly and two connecting rods, and the two sets of bearing assembly and two connecting rods are fixed to each other to form a rectangular shape, wherein the two sets of bearing assembly are oppositely disposed, and the first restricting members are fixed to the two sets of bearing assembly.

In some embodiments, each of the two sets of bearing assembly includes a front bearing plate and a back bearing plate fixed to each other, wherein both ends of one of the two connecting rods are fixed to corresponding two front bearing plates, and both ends of the other of the two connecting rods are fixed to the two back bearing plates, respectively; and along a length direction of the synchronizing rod, each of the two transmission plates is located between corresponding one of the two front bearing plate and corresponding one of the two back bearing plates; and each of the two transmission plates is rotatably connected to corresponding one of the two front bearing plate.

In some embodiments, each of the two sets of bearing assembly includes a reinforcing rod, both ends of the reinforcing rod are fixed to corresponding one of the two front bearing plates and corresponding one of the two connecting rods, respectively.

In some embodiments, the first restricting members are fixed to an outer side of the two front bearing plates.

In some embodiments, the chair frame includes two sets of extending assembly disposed at both sides of the bearing framework, each of the two sets of extending assembly includes a transmission assembly and a leg assembly, the leg assembly is connected to corresponding one of two the back bearing plates; the transmission assembly includes a first transmission rod, a second transmission rod and a third transmission rod, one end of the first transmission rod is rotatably connected to a corresponding transmission plate, a connecting position of the first transmission rod and the corresponding transmission plate is located on a opposite side of a connecting position of the corresponding transmission plate and the synchronizing rod with a connecting position of the corresponding transmission plate and the front bearing plate as a center, and the connecting position of the first transmission rod and the corresponding transmission plate is on the other side of the connecting position of the corresponding transmission plate and the synchronizing rod; and the other end of the first transmission rod is rotatably connected to one end of the second transmission rod, the other end of the second transmission rod is rotatably connected to the back bearing plate, one end of the third transmission rod is rotatably connected to the first transmission rod, and the other end of the third transmission rod is rotatably connected to the leg assembly.

In some embodiments, the transmission assembly further includes an elastic member connected between the third transmission rod and the back bearing plate.

In some embodiments, the leg assembly includes a first leg rod, a second leg rod, a third leg rod, a fourth leg rod and a foot assembly, both the first leg rod and the second leg rod are rotatably connected to the back bearing plate, the third transmission rod is rotatably connected to the second leg rod, the third leg rod is rotatably connected to the first leg rod and the second leg rod, respectively, the fourth leg rod is rotatably connected to the first leg rod, and the foot assembly is rotatably connected to the third leg rod and the fourth leg rod, respectively.

In some embodiments, the foot assembly includes a first foot rod, a second foot rod, a third foot rod, a first foot support member and a second foot support member. The first foot support member, the first foot rod, the second foot rod and the fourth leg rod are successively rotatably connected to each other and define a rectangular shape, and the second foot support member, the fourth leg rod, the second foot rod and the third foot rod are successively rotatably connected to each other and define a rectangular shape.

In some embodiments, a second restricting member is fixed to the first leg rod. When the leg assembly is completely retracted, the second restricting member abuts against the third leg rod.

In some embodiments, a third restricting member is fixed to the back bearing plate. When the leg assembly is completely retracted, the second leg rod abuts against the third restricting member.

In some embodiments, the chair frame includes two sets of lifting assembly disposed at both sides of the bearing framework, respectively, each of the two sets of the lifting assembly includes a first lifting rod and a second lifting rod, one end of the first lifting rod and one end of the second lifting rod are rotatably connected to the corresponding front bearing plate, the other end of the first lifting rod and the other end of the second lifting rod are rotatably connected to the pedestal.

In some embodiments, the chair frame further includes a waist support assembly. The waist support assembly includes a second push rod, a waist support synchronizing rod and two waist support plates, two ends of the second push rod are pivotably connected to the waist support synchronizing rod and the connecting rod fixed to the front bearing plate, the two waist support plates are rotatably connected to the two back bearing plates disposed at both sides of the chair frame, respectively, and both ends of the waist support synchronizing rod are connected to the two waist support plates, respectively.

In a second aspect of the present disclosure, a chair including the chair frame described above is provided.

### BRIEF DESCRIPTION OF THE DRAWINGS

FIG. 1 is a stereo schematic diagram of a bearing framework in a chair frame of the present disclosure.

FIG. 2 is a stereo schematic diagram of a bearing framework and a driving assembly in a chair frame of the present disclosure.

FIG. 3 is a stereo schematic diagram of a chair frame of the present disclosure in a first state.

FIG. 4 is a stereo schematic diagram of a chair frame of the present disclosure in a second state.

FIG. 5 is a stereo schematic diagram of a chair frame of the present disclosure in a third state.

FIG. 6 is a front view of an extending assembly in FIG. 3.

FIG. 7 is a front view of FIG. 4.

FIG. 8 is a front view of a pedestal, a lifting assembly, a front bearing plate and a transmission plate in FIG. 4.

FIG. 9 is a front view of a pedestal, a lifting assembly, a front bearing plate and a transmission plate in FIG. 5.

In the figures, 100 represents a chair frame; 10 represents a pedestal; 20 represents a lifting assembly; 21 represents a first lifting rod; 22 represents a second lifting rod; 30 represents a driving assembly; 31 represents a first push rod; 32 represents a synchronizing rod; 33 represents a transmission plate;

40 represents a bearing framework; 41 represents a bearing assembly; 411 represents a front bearing plate 411a represents a first restricting member; 412 represents a back bearing plate; 412a represents a third restricting member; 413 represents a reinforcing rod; 42 represents a connecting rod;

50 represents an extending assembly; 51 represents a transmission assembly; 511 represents a first transmission rod; 512 represents a second transmission rod; 513 represents a third transmission rod; 514 represents a elastic member; 52 represents a leg assembly; 521 represents a first leg rod; 521a represents a second restricting member; 522 represents a second leg rod; 523 represents a third leg rod; 524 represents a fourth leg rod; 53 represents a foot assembly; 531 represents a first foot rod; 532 represents a second foot rod; 533 represents a third foot rod; 534 represents a first foot support member; 535 represents a second foot support member;

60 represents a waist support assembly; 61 represents a second push rod; 62 represents a waist support synchronizing rod; and 63 represents a waist support plate.

### DETAILED DESCRIPTION

In order that the foregoing purposes, features and advantages of the present disclosure may be made more apparent and understandable, specific embodiments of the present disclosure are described in detail below in conjunction with the accompanying drawings. Many specific details are set forth in the following description to facilitate a full understanding of the present disclosure. However, the present disclosure is capable of being implemented in many other ways different from those described herein, and those skilled in the art may make similar improvements without violating the connotations of the present disclosure, and thus the present disclosure is not limited by the specific embodiments disclosed below.

In the description of the present disclosure, it is to be understood that the terms “centre”, “longitudinal”, “transverse”, “length”, “width”, “thickness”, “top”, “bottom”, “front”, “back”, “left”, “right”, “vertical”, “horizontal”, “upon”, “below”, “left”, “right”, “vertical”, “horizontal”, “top”, “bottom”, “inside”, “outside”, “clockwise”, “counterclockwise”, “axial”, “radial”, “circumferential” and the like indicate orientation or positional relationships based on those shown in the accompanying drawings, and are only intended to facilitate the description of the present disclosure and to simplify the description, rather than indicating or implying that the device or element referred to must have a specific orientation, construction and operation in a specific orientation, and therefore cannot be understood as a limitation of the present disclosure.

Furthermore, the terms “first” and “second” are used for descriptive purposes only and are not to be understood as indicating or implying relative importance or implicitly specifying the number of technical features indicated. Thus, a feature defined with “first”, “second” may include at least one such feature, either explicitly or implicitly. In the description of the present disclosure, “plurality” means at least two, e.g., two, three, etc., unless otherwise expressly limited.

In the present disclosure, the terms “mounting”, “connecting”, “abutting”, “fixing” and the like are to be understood in a broad sense, e.g., as a fixed connection, a removable connection, or a one-piece unit, unless otherwise expressly specified and limited. The connection may be a mechanical connection or an electrical connection; a direct connection or an indirect connection via an intermediate medium; a communication within the two elements or an interactive relationship between the two elements, unless expressly limited otherwise. For those of ordinary skill in the art, the specific meanings of the above terms in the present disclosure may be understood on a case-by-case basis.

In the present utility model, unless otherwise expressly provided and limited, the first feature being “above” or “below” the second feature may be a direct contact between the first and second features, or an indirect contact between the first and second features through an intermediate medium. Furthermore, the first feature being “above”, “on” or “upon” the second feature may mean that the first feature is directly above or diagonally above the second feature, or it may simply mean that the first feature is horizontally higher than the second feature. The first feature being “below”, “under”, “underneath” the second feature may be that the first feature is directly below or diagonally below the second feature, or may simply mean that the first feature is horizontally smaller than the second feature.

It is noted that when a component is said to be “fixed to” or “disposed on” another component, it may be directly on the other component or there may be a centred component. When a component is said to be “connected” to another component, it may be directly connected to the other component or there may be both centred components. The terms “vertical”, “horizontal”, “up”, “down”, “left”, “right” and similar expressions used in the specification of the present application are for illustrative purposes only and are not meant to be exclusive.

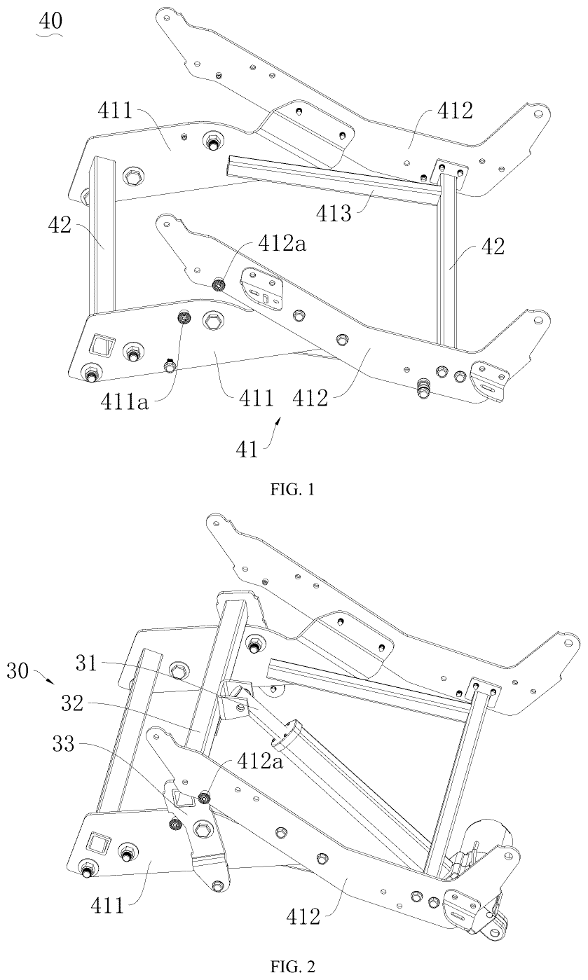

Referring to FIG. 1 to FIG. 5, the present disclosure firstly provides a chair from, which includes a pedestal 10, a lifting assembly 20, a driving assembly 30, a bearing framework 40 and an extending assembly 50. First restricting members 411a are fixed to both sides of the bearing framework 40; the driving assembly 30 includes a first push rod 31, a synchronizing rod 32 and two transmission plates 33. One end of the first push rod 31 is pivotally connected to the pedestal 10, and the other end of the first push rod 31 is pivotally connected to the synchronizing rod 32. Both ends of the synchronizing rod 32 are fixed to one of the two transmission plates 33, respectively. Each of the two transmission plates 33 is rotatably connected to a side of the bearing framework 40, respectively, and the two transmission plates 33 are capable of rotating until to abut against a corresponding first restricting member 411a. The lifting assembly 20 is connected between the bearing framework 40 and the pedestal 10, and the extending assembly 50 is connected to the bearing framework 40. When each of the two transmission plates 33 abuts against the corresponding first restricting member 411a, the first push rod 31 is capable of retracting or extending to drive the lifting assembly 20 to retract or extend; and when each of the two transmission plates 33 separates from the corresponding first restricting member 411a, the first push rod 31 is capable of retracting or extending to drive the extending assembly 50 to retract or extend.

In the present disclosure, by rotating the transmission plate 33 connected to the bearing framework 40 and the first restricting member 411a fixed to the bearing framework 40, the first push rod 1 can be retracted or extended to different states. The transmission plate 33 has a state in which the transmission plate 33 can rotate relative to the bearing framework 40 and a state in which the transmission plate 33 abuts against the first restricting member 411a and cannot rotate. In the two states, in the process that the first push rod 31 retracts or extends, the first push rod 31 can drive different members to move. In this way, the lifting assembly 20 and the extending assembly 50 can be driven merely by the first push rod 31. The number of components of the chair frame is reduced, facilitating assembly of the chair frame while lowering the cost.

It should be noted that in related art, some of the chair frames can drive a plurality of components to move with one actuator. However, this kind of chair frames have a complex guiding and restricting structure, a driving direction of the actuator is adjusted by overlapping a great amount of workpieces. Compared with the guiding groove structure in the related art, an external restricting structure in which the transmission plate 33 and the first restricting member 411a cooperates with each other is used in the present disclosure, the structure is simplifier and the assembly is more convenient.

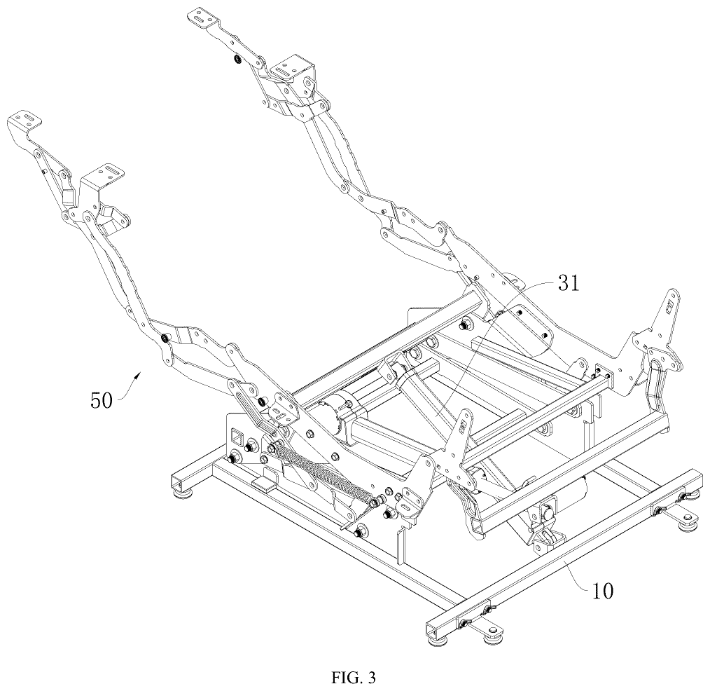

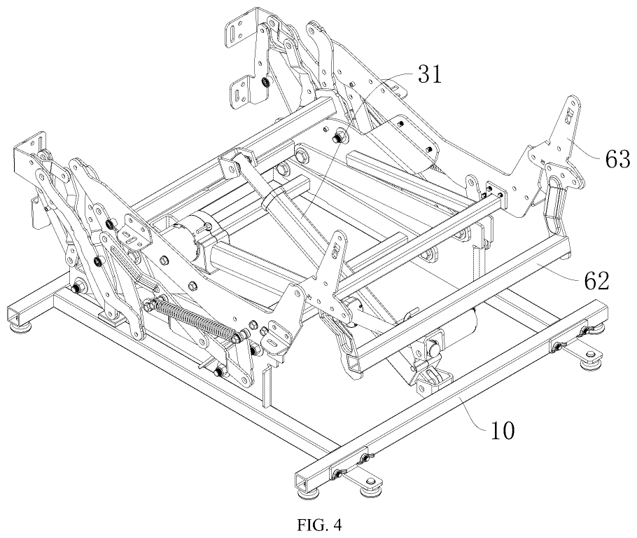

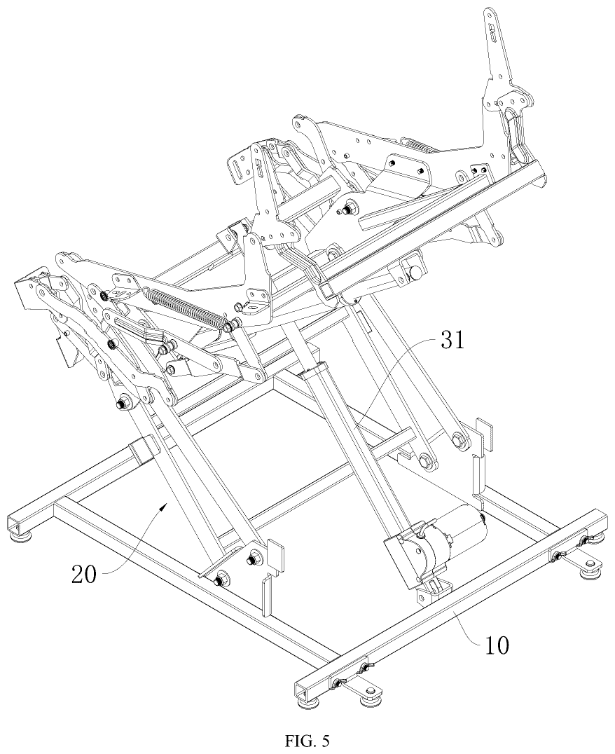

Referring to FIG. 3, FIG. 4 and FIG. 5, the chair frame in the present disclosure has a first state, a second state and a third state, in which the first push rod 31 is completely retracted, partly extended and completely extended, respectively.

In the first state, the transmission plate 33 separates from the first restricting member 411a. At this time, the first push rod 31 is completely retracted, the extending assembly 50 is completely extended, and the lifting assembly 20 is completely retracted.

While the first push rod 31 is gradually extending out, the chair frame transforms from the first state to the second state. In the process the first push rod 31 extends out, the transmission plate 33 separates from the first restricting member 411a from beginning to end, the transmission plate 33 can rotate relative to the front bearing plate 411. Therefore, the transmission plate 33 is driven to rotate while the first push rod 31 extending, so that the extending assembly 50 is driven to gradually retract. In addition, in the process the first push rod 31 extends out, the lifting assembly 20 is not driven to move until the chair frame transforms to the second state.

When the chair frame is transformed to the second state, the transmission plate 33 abuts against the first restricting member 411a. At the same time, the first push rod 31 partly extends out, and both the extending assembly 50 and the lifting assembly 20 are completely retracted.

While the first push rod 31 is further extending out, the chair frame transforms from the second state to the third state. In the process the chair frame transforms from the second state to the third state, since the transmission plate 33 abuts against the first restricting member 411a, the transmission plate 33 cannot rotate relative to the front bearing plate 411 any more. Therefore, the first push rod 31 extends out to drive the lifting assembly 20 to gradually extend via the transmission plate 33, while not driving the extending assembly 50 to move until the chair frame transforms to the third state.

When the chair frame transforms to the third state, the first push rod 31 completely extends out, the extending assembly 50 completely retracts and the lifting assembly 20 completely extends out.

Referring to FIG. 1, in some embodiments, the bearing framework 40 includes two sets of bearing assembly 41 and two connecting rods 42, and the two sets of bearing assembly 41 and two connecting rods 42 are fixed to each other to define a rectangular shape, wherein the two sets of bearing assembly 41 are oppositely disposed, and the first restricting members 411a are fixed to the two sets of bearing assembly 41.

In the present disclosure, since the bearing assembly 41 and the connecting rod 42 are fixed together to define a rectangular-shape bearing framework 40, right-left balance of the chair frame in the process the chair frame transforms from the second state to the third state is improved, and the structure of the chair frame is more tighten.

Referring to FIG. 1, in some embodiments, each of the two sets of bearing assembly 41 includes a front bearing plate 411 and a back bearing plate 412 fixed to each other, wherein both ends of one of the two connecting rods 42 are fixed to the two front bearing plates 411, and both ends of the other of the two connecting rods 42 are fixed to the two back bearing plates 412, respectively; and along a length direction of the synchronizing rod 32, one of the two transmission plates 33 is located between the corresponding one of the two front bearing plate 411 and the corresponding one of the two back bearing plates 412; and the transmission plate 33 of the two transmission plates 33 is rotatably connected to the corresponding bearing plates 411.

In some embodiments, the front bearing plate 411 is provided with a bending portion, so that a gap is located between the front bearing plate 411 and the back bearing plate 412 along the length direction of the synchronizing rod 32, so as to accommodate the transmission plate 33 and provide a space for the transmission plate 33 to rotate. Since the transmission plate 33 is disposed between the front bearing plate 411 and the back bearing plate 412, interference between the transmission plate 33 and other components is avoided.

In some embodiments, the bearing assembly 41 can be an integral structure, or a complex assembly having a plurality of members, which is not further limited in the present disclosure.

Referring to FIG. 1, in some embodiments, each set of the bearing assembly 41 further includes a reinforcing rod 413. Both ends of the reinforcing rod 413 are fixed to the front bearing plate 411 and the connecting rod 42, respectively. The reinforcing rod 413 can improve structure strength of the bearing framework 40, so that firmness of the chair frame and balance and stability of the chair frame in the state-changing process are further improved.

Referring to FIG. 1, in some embodiments, the first restricting members 411a are fixed to an outer side of the two front bearing plates 411. The outer side of the two front bearing plates 411 herein refers to sides of each of the two front bearing plates 411 away from each other. Since the first restricting members 411a are fixed to the outer side of the two front bearing plates 411, assembly difficulty of the first restricting members 411a is effectively lowered.

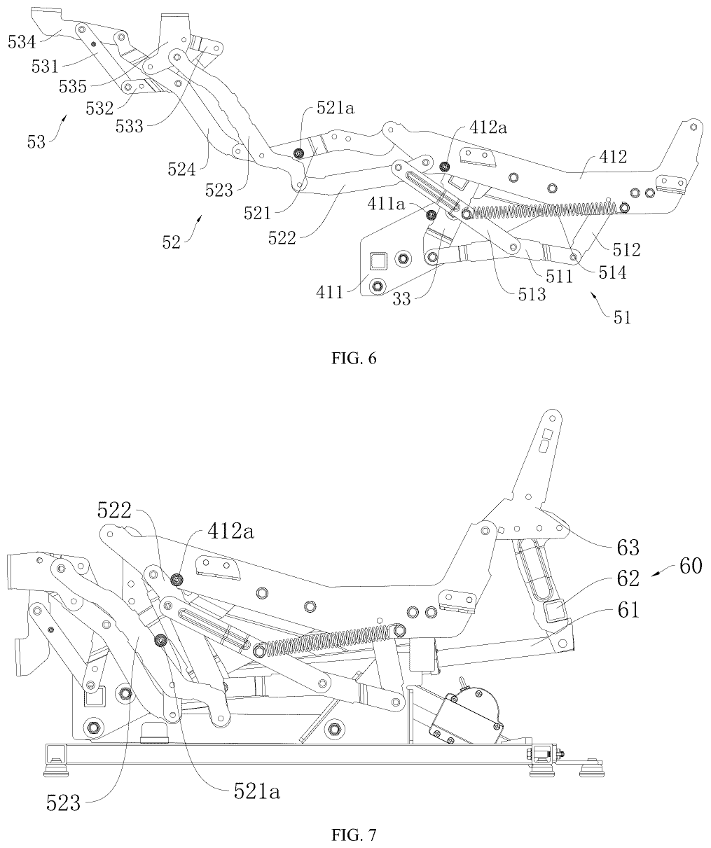

Referring to FIG. 3, FIG. 4, FIG. 6 and FIG. 7, in some embodiments, the chair frame includes two sets of extending assembly 50 disposed at both sides of the bearing framework 40, each of the two sets of extending assembly 50 includes a transmission assembly 51 and a leg assembly 52. The leg assembly 52 is connected to the back bearing plate. The transmission assembly 51 includes a first transmission rod 511, a second transmission rod 512 and a third transmission rod 513, one end of the first transmission rod 511 is rotatably connected to a corresponding transmission plage 33, a connecting position of the first transmission rod 511 and the transmission plage 33 is located on a opposite side of a connecting position of the transmission plage 33 and the synchronizing rod 32 with a connecting position of the transmission plage 33 and the front bearing plate 411 as a center, and the connecting position of the first transmission rod 511 and the transmission plage 33 is on the other side of the connecting position of the transmission plage 33 and synchronizing rod 32; and the other end of the first transmission rod 511 is rotatably connected to one end of the second transmission rod 512, the other end of the second transmission rod 512 is rotatably connected to the back bearing plate 412, one end of the third transmission rod 513 is rotatably connected to the first transmission rod 511, and the other end of the third transmission rod 513 is rotatably connected to the leg assembly 52.

The process of the chair frame transforming from the first state to the second state is taken as an example. In the process, the chair frame transforms from a lying state in which the extending assembly 50 completely extends out to a sitting state in which the extending assembly 50 completely retracts.

Referring to FIG. 6, extending of the first push rod 31 can drive the synchronizing rod 32 to move forward, so as to drive the transmission plate 33 to rotate. The middle part of the transmission plate 33 is rotatably connected to the front bearing plate 411, and moving forward of the synchronizing rod 32 can drive an upper end of the transmission plate 33 to move to the left side of FIG. 6, that is, driving the transmission plate 33 to move along an anticlockwise direction in the figure (in the process, the transmission plate 33 will not be blocked by the first restricting member 411a). Therefore, the first transmission rod 511 and the second transmission rod 512 are driven to move towards the right side of the figure, wherein moving right of the first transmission rod 511 can drive the third transmission rod 513 to move to the right; vice versa, moving of the third transmission rod 513 drives the leg assembly 52 to retract or extend.

In some embodiment, the transmission assembly 51 can be a connecting rod set having other structures or being disposed in other forms, as long as the leg assembly 52 can be driven to retract or extend by the transmission plate 33, which is not further limited in the present disclosure.

Referring to FIG. 6 and FIG. 7, in some embodiments, the transmission assembly 51 further includes an elastic member 514 connected between the third transmission rod 513 and the back bearing plate 412. The elastic member 514 can accumulate elastic force by deformation in the process that the transmission assembly 51 extends or retracts, and release the elastic force when the transmission assembly 51 moves in an opposite direction and assist the transmission assembly 51 to move, so as to avoid a jam of the transmission assembly 51.

In some embodiments, the elastic member 514 is a tension spring. In the process the transmission assembly 51 extends out, the elastic member 514 deforms and extends. In the process the transmission assembly 51 retracts, the elastic member 514 recovers and assists the transmission assembly 51 to retract.

Referring to FIG. 3, FIG. 4, FIG. 6 and FIG. 7, in some embodiments, the leg assembly 52 includes a first leg rod 521, a second leg rod 522, a third leg rod 523, a fourth leg rod 524 and a foot assembly 53. Both the first leg rod 521 and the second leg rod 522 are rotatably connected to the back bearing plate 412, the third transmission rod 513 is rotatably connected to the second leg rod 522, the third leg rod 523 is rotatably connected to the first leg rod 521 and the second leg rod 522, respectively, the fourth leg rod 524 is rotatably connected to the first leg rod 521, and the foot assembly 53 is rotatably connected to the third leg rod 523 and the fourth leg rod 524, respectively.

The leg assembly 52 can support a user's leg after the leg assembly extends out, so as to meet requirement of the laying state of the user. Thus, the chair can be used more broadly and more comfortable.

The process of the chair frame transforming from the first state to the second state is taken as an example. In the process, the chair frame transforms from a lying state in which the extending assembly 50 completely extends out to a sitting state in which the extending assembly 50 completely retracts.

Referring to FIG. 6, extending out of the first push rod 31 may drive the third transmission rod 513 to move to the right. Since the third transmission rod 513 is rotatably connected to the second leg rod 522, and the second leg rod 522, the third leg rod 523, the first leg rod 521 and the fourth leg rod 524 are successively connected to each other, the third transmission rod 513 can synchronously drive the second leg rod 522, the third leg rod 523, the first leg rod 521 and the fourth leg rod 524 to move to the right while the third transmission rod 513 is moving to the right. Vice versa, moving of the third transmission rod 513 can drive the leg assembly 52 to extend or retract.

In some embodiment, leg assembly 52 can be a connecting rod set having other structures or being disposed in other forms, as long as the leg assembly 52 can be driven to retract or extend by the third transmission rod 513, which is not further limited in the present disclosure.

Referring to FIG. 6 and FIG. 7, in some embodiments, the foot assembly 53 includes a first foot rod 531, a second foot rod 532, a third foot rod 533, a first foot support member 534 and a second foot support member 535. The first foot support member 534, first foot rod 531, the second foot rod 532 and the fourth leg rod 524 are successively rotatably connected to each other and define a rectangular shape, and the second foot support member 535, the fourth leg rod 524, the second foot rod 532 and the third foot rod 533 are successively rotatably connected to each other and define a rectangular shape.

The foot assembly 53 can further increase a retracting length and an extending length of the extending assembly 50, so as to increase comfortableness of the user in the laying state. Referring to FIG. 6, the middle part of the second foot rod 532 is connected to the fourth leg rod 524; a left part of the second foot rod 532, the fourth leg rod 524, the first foot support member 534 and the first foot rod 531 surround to define a rectangular shape; and a right part of the second foot rod 532, the third foot rod 533, the second foot support member 535 and the fourth leg rod 524 surround to define a rectangular shape.

The process of the chair frame transforming from the first state to the second state is taken as an example. In the process, the chair frame transforms from a lying state in which the extending assembly 50 completely extends out to a sitting state in which the extending assembly 50 completely retracts.

Referring to FIG. 6, extending of the first push rod 31 may drive the leg assembly 52 to retract, that is, driving the third leg rod 523 and the fourth leg rod 524 to retract to a lower right direction. Since the second foot support member 535 is rotatably connected to both the third leg rod 523 and the fourth leg rod 524, changing of relative position between the third leg rod 523 and the fourth leg rod 524 may drive the second foot support member 535 to rotate or overlap while the third leg rod 523 and the fourth leg rod 524 moves. The second foot support member 535 anticlockwise rotates in the center of a connecting position between the second foot support member 535 and the fourth leg rod 524, so that the second foot rod 532 is driven to rotate by the third foot rod 533. The second foot rod 532 anticlockwise rotates in the center of the second foot rod 532 and the fourth leg rod 524, so that the first foot rod 531 drives the first foot support member 534 to rotate and overlap. In this way, the first foot support 534 and the second foot support member 535 are retracted and overlapped with each other. Vise versa.

In some embodiment, the foot assembly 53 can be a connecting rod set having other structures or being disposed in other forms, as long as the foot assembly 53 can be driven to retract or extend by the third leg rod 523 and the fourth leg rod 524, which is not further limited in the present disclosure.

Referring to FIG. 6 and FIG. 7, in some embodiments, a second restricting member 521a is fixed to the first leg rod 521. When the leg assembly 52 is completely retracted, the second restricting member 521a abuts against the third leg rod 523. A third restricting member 412a is fixed to the back bearing plate 412. When the leg assembly 52 is completely retracted, the second leg rod 522 abuts against the third restricting member 412a.

The second restricting member 521a and third restricting member 412a can limit an extreme retracting position of the third leg rod 523 and an extreme retracting position of the second leg rod 522 when the extending assembly 50 retracts, and avoids conditions that the components interferes with each other or the components cannot reset.

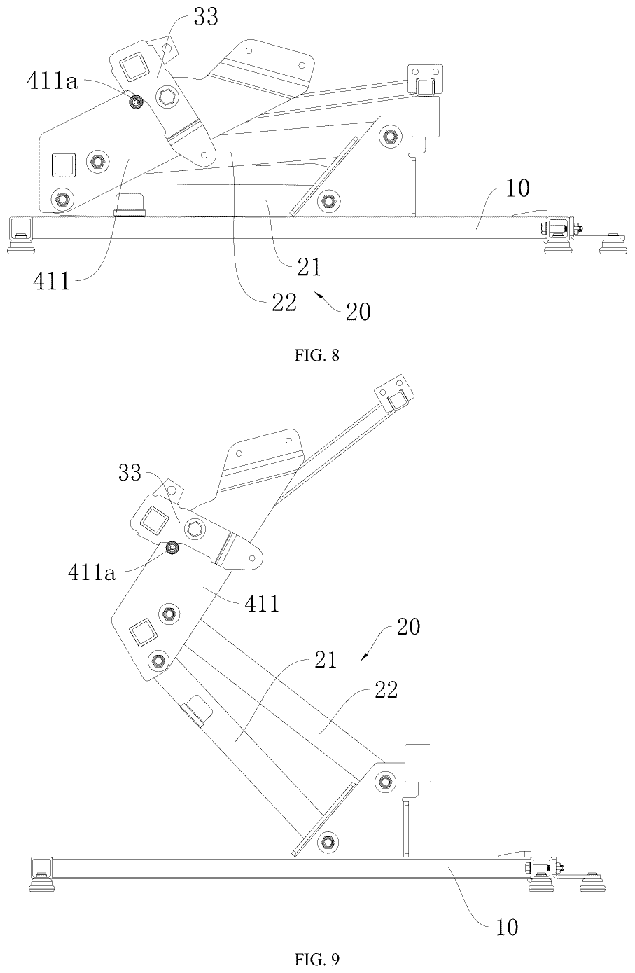

Referring to FIG. 4, FIG. 5, FIG. 8 and FIG. 9, in some embodiments, the chair frame includes two sets of lifting assembly 20 disposed at both sides of the bearing framework 40, respectively. Each of the two sets of the lifting assembly 20 includes a first lifting rod 21 and a second lifting rod 22. One end of the first lifting rod 21 and one end of the second lifting rod 22 are rotatably connected to the corresponding front bearing plate 411, the other end of the first lifting rod 21 and the other end of the second lifting rod 22 are rotatably connected to the pedestal 10.

The process of the chair frame transforming from the second state to the third state is taken as an example. In the process, the chair frame transforms from the sitting state in which the lifting assembly 20 completely retracts to a standing state in which the lifting assembly 20 completely extends out.

Referring to FIG. 8, in the process the first push rod 31 extends out, the transmission plate 33 has a tendency to move to the upper left and to move anticlockwise as shown in the figure. However, since the transmission plate 33 abuts against the first restricting member 411a, the transmission plate 33 cannot rotate any more. Thus, the bearing framework 40 has a tendency to move to the upper left as shown in FIG. 8 under the driving of the transmission plate 33, and drives the first lifting rod 21 and the second lifting rod to rotate anticlockwise. Vice versa, the first push rod 31 retracts or extends to drive the lifting assembly 20 to retract or extend.

In some embodiment, the lifting assembly 20 can be a connecting rod set having other structures or being disposed in other forms, as long as the lifting assembly 20 can be driven to retract or extend by the first push rod 31, which is not further limited in the present disclosure.

Referring to FIG. 4 and FIG. 7, in some embodiments, the chair frame further includes a waist support assembly 60. The waist support assembly 60 includes a second push rod 61, a waist support synchronizing rod 62 and two waist support plates 63. Two ends of the second push rod 61 are pivotably connected to the waist support synchronizing rod 62 and the connecting rod 42 fixed to the front bearing plate 411. The two waist support plates 63 are rotatably connected to the two back bearing plates disposed at both sides of the chair frame, respectively, and both ends of the waist support synchronizing rod 62 are connected to the two waist support plates 63, respectively.

The second push rod 61 extends or retracts to drive the two waist support plates 63 to rotate via the waist support synchronizing rod 62, so that the waist support plate 63 rotates in the center of a connecting position of the waist support plage 63 and the back bearing plate 412, thereby adjusting the support to the waist.

In some embodiment, the chair frame provided in the present disclosure can drive a plurality of components with one actuator and apply an external restricting structure in which the transmission plate 33 cooperates with the first restricting member 411a. Compared with the guiding groove structure in the related art, the chair frame has a simpler structure, is more convenient to assemble and is more convenient to be used in a chair for seniors.

In a second aspect of the present disclosure, a chair which includes the chair frame described above is provided.

In some embodiments of the present disclosure, the chair is a chair for seniors.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above-described embodiments are only several implementations of the present disclosure, and the descriptions are relatively specific and detailed, but they should not be construed as limiting the scope of the present disclosure. It should be understood by those of ordinary skill in the art that various modifications and improvements can be made without departing from the concept of the present disclosure, and all fall within the protection scope of the present disclosure. Therefore, the patent protection of the present disclosure shall be defined by the appended claims.

What is claimed is:

1. A chair frame, comprising a pedestal, a lifting assembly, a driving assembly, a bearing framework and an extending assembly;
wherein first restricting members are fixed to both sides of the bearing framework;
the driving assembly comprises a first push rod, a synchronizing rod and two transmission plates, one end of the first push rod is pivotally connected to the pedestal, the other end of the first push rod is pivotally connected to the synchronizing rod, both ends of the synchronizing rod are fixed to one of the two transmission plates, respectively, each of the two transmission plates is connected to a side of the bearing framework, respectively, and the two transmission plates are capable of rotating relative to the framework, respectively, and the two transmission plates are capable of rotating until to abut against a corresponding first restricting member, and
the lifting assembly is connected between the bearing framework and the pedestal, and the extending assembly is connected to the bearing framework;
when each of the two transmission plates abuts against the corresponding first restricting member, the first push rod is capable of extending or retracting to drive the lifting assembly to extend or retract, and when each of the two transmission plates separates from the corresponding first restricting member, the first push rod is capable of retracting or extending to drive the extending assembly to retract or extend.

2. The chair frame of claim 1, wherein the bearing framework comprises two sets of bearing assembly and two connecting rods, and the two sets of bearing assembly and two connecting rods are fixed to each other to form a rectangular shape,
wherein the two sets of bearing assembly are oppositely disposed, and the first restricting members are fixed to the two sets of bearing assembly.

3. The chair frame of claim 2, wherein each of the two sets of bearing assembly comprises a front bearing plate and a back bearing plate fixed to each other,
wherein both ends of one of the two connecting rods are fixed to corresponding two front bearing plates, and both ends of the other of the two connecting rods are fixed to corresponding two back bearing plates, respectively; and along a length direction of the synchronizing rod, each of the two transmission plates is located between corresponding one of the two front bearing plate and corresponding one of the two back bearing plates;
and each of the two transmission plates is rotatably connected to corresponding one of the two front bearing plate.

4. The chair frame of claim 3, wherein each of the two sets of bearing assembly comprises a reinforcing rod, both ends of the reinforcing rod are fixed to corresponding one of the two front bearing plates and corresponding one of the two connecting rods, respectively; and/or, the first restricting members are fixed to an outer side of the two front bearing plates.

5. The chair frame of claim 3, further comprising two sets of extending assembly disposed at both sides of the bearing framework, wherein each of the two sets of extending assembly comprises a transmission assembly and a leg assembly, the leg assembly is connected to corresponding one of the two back bearing plates;
the transmission assembly comprises a first transmission rod, a second transmission rod and a third transmission rod, one end of the first transmission rod is rotatably connected to a corresponding transmission plate, a connecting position of the first transmission rod and the corresponding transmission plate is located on a opposite side of a connecting position of the corresponding transmission plate and the synchronizing rod with a connecting position of the corresponding transmission plate and the front bearing plate as a center, and the connecting position of the first transmission rod and the corresponding transmission plate is on the other side of the connecting position of the corresponding transmission plate and synchronizing rod; and the other end of the first transmission rod is rotatably connected to one end of the second transmission rod, the other end of the second transmission rod is rotatably connected to the back bearing plate, one end of the third transmission rod is rotatably connected to the first transmission rod, and the other end of the third transmission rod is rotatably connected to the leg assembly.

6. The chair frame of claim 5, wherein the transmission assembly further comprises an elastic member connected between the third transmission rod and the back bearing plate.

7. The chair frame of claim 5, wherein the leg assembly comprises a first leg rod, a second leg rod, a third leg rod, a fourth leg rod and a foot assembly,
both the first leg rod and the second leg rod are rotatably connected to the back bearing plate, the third transmission rod is rotatably connected to the second leg rod, the third leg rod is rotatably connected to the first leg rod and the second leg rod, respectively, the fourth leg rod is rotatably connected to the first leg rod, and the foot assembly is rotatably connected to the third leg rod and the fourth leg rod, respectively.

8. The chair frame of claim 7, wherein the foot assembly comprises a first foot rod, a second foot rod, a third foot rod, a first foot support member and a second foot support member,
the first foot support member, the first foot rod, the second foot rod and the fourth leg rod are successively rotatably connected to each other and define a rectangular shape, the second foot support member, the fourth leg rod, the second foot rod and the third foot rod are successively rotatably connected to each other and define a rectangular shape; and/or,
a second restricting member is fixed to the first leg rod, when the leg assembly is completely retracted, the second restricting member abuts against the third leg rod; and/or,
a third restricting member is fixed to the back bearing plate, when the leg assembly is completely retracted, the second leg rod abuts against the third restricting member.

9. The chair frame of claim 3, further comprising two sets of lifting assembly disposed at both sides of the bearing framework, respectively, wherein each of the two sets of the lifting assembly comprises a first lifting rod and a second lifting rod, one end of the first lifting rod and one end of the second lifting rod are rotatably connected to the corresponding front bearing plate, the other end of the first lifting rod and the other end of the second lifting rod are rotatably connected to the pedestal; and/or,
the chair frame further comprises a waist support assembly, the waist support assembly comprises a second push rod, a waist support synchronizing rod and two waist support plates, two ends of the second push rod are pivotably connected to the waist support synchronizing rod and the connecting rod fixed to the front bearing plate, the two waist support plates are rotatably connected to the two back bearing plates disposed at both sides of the chair frame, respectively, and both ends of the waist support synchronizing rod are connected to the two waist support plates, respectively.

10. A chair, comprising the chair frame of claim 1, wherein the chair frame comprises a pedestal, a lifting assembly, a driving assembly, a bearing framework and an extending assembly;
wherein first restricting members are fixed to both sides of the bearing framework;
the driving assembly comprises a first push rod, a synchronizing rod and two transmission plates, one end of the first push rod is pivotally connected to the pedestal, the other end of the first push rod is pivotally connected to the synchronizing rod, both ends of the synchronizing rod are fixed to one of the two transmission plates, respectively, each of the two transmission plates is connected to a side of the bearing framework, respectively, and the two transmission plates are capable of rotating relative to the framework, respectively, and the two transmission plates are capable of rotating until to abut against a corresponding first restricting member, and
the lifting assembly is connected between the bearing framework and the pedestal, and the extending assembly is connected to the bearing framework;
when each of the two transmission plates abuts against the corresponding first restricting member, the first push rod is capable of extending or retracting to drive the lifting assembly to extend or retract, and when each of the two transmission plates separates from the corresponding first restricting member, the first push rod is capable of retracting or extending to drive the extending assembly to retract or extend.

11. The chair of claim 10, wherein the bearing framework comprises two sets of bearing assembly and two connecting rods, and the two sets of bearing assembly and two connecting rods are fixed to each other to form a rectangular shape,
wherein the two sets of bearing assembly are oppositely disposed, and the first restricting members are fixed to the two sets of bearing assembly.

12. The chair of claim 11, wherein each of the two sets of bearing assembly comprises a front bearing plate and a back bearing plate fixed to each other,
wherein both ends of one of the two connecting rods are fixed to corresponding two front bearing plates, and both ends of the other of the two connecting rods are fixed to corresponding two back bearing plates, respectively; and along a length direction of the synchronizing rod, each of the two transmission plates is located between corresponding one of the two front bearing plate and corresponding one of the two back bearing plates;
and each of the two transmission plates is rotatably connected to corresponding one of the two front bearing plate.

13. The chair of claim 12, wherein each of the two sets of bearing assembly comprises a reinforcing rod, both ends of the reinforcing rod are fixed to corresponding one of the two front bearing plates and corresponding one of the two connecting rods, respectively; and/or,
the first restricting members are fixed to an outer side of the two front bearing plates.

14. The chair of claim 12, further comprising two sets of extending assembly disposed at both sides of the bearing framework, wherein each of the two sets of extending assembly comprises a transmission assembly and a leg assembly, the leg assembly is connected to corresponding one of the two back bearing plates;
the transmission assembly comprises a first transmission rod, a second transmission rod and a third transmission rod, one end of the first transmission rod is rotatably connected to a corresponding transmission plate, a connecting position of the first transmission rod and the corresponding transmission plate is located on a opposite side of a connecting position of the corresponding transmission plate and the synchronizing rod with a connecting position of the corresponding transmission plate and the front bearing plate as a center, and the connecting position of the first transmission rod and the corresponding transmission plate is on the other side of the connecting position of the corresponding transmission plate and synchronizing rod; and the other end of the first transmission rod is rotatably connected to one end of the second transmission rod, the other end of the second transmission rod is rotatably connected to the back bearing plate, one end of the third transmission rod is rotatably connected to the first transmission rod, and the other end of the third transmission rod is rotatably connected to the leg assembly.

15. The chair of claim 14, wherein the transmission assembly further comprises an elastic member connected between the third transmission rod and the back bearing plate.

16. The chair of claim 14, wherein the leg assembly comprises a first leg rod, a second leg rod, a third leg rod, a fourth leg rod and a foot assembly,
both the first leg rod and the second leg rod are rotatably connected to the back bearing plate, the third transmission rod is rotatably connected to the second leg rod, the third leg rod is rotatably connected to the first leg rod and the second leg rod, respectively, the fourth leg rod is rotatably connected to the first leg rod, and the foot assembly is rotatably connected to the third leg rod and the fourth leg rod, respectively.

17. The chair of claim 16, wherein the foot assembly comprises a first foot rod, a second foot rod, a third foot rod, a first foot support member and a second foot support member,
the first foot support member, the first foot rod, the second foot rod and the fourth leg rod are successively rotatably connected to each other and define a rectangular shape, the second foot support member, the fourth leg rod, the second foot rod and the third foot rod are successively rotatably connected to each other and define a rectangular shape; and/or,
a second restricting member is fixed to the first leg rod, when the leg assembly is completely retracted, the second restricting member abuts against the third leg rod; and/or,
a third restricting member is fixed to the back bearing plate, when the leg assembly is completely retracted, the second leg rod abuts against the third restricting member.

18. The chair of claim 12, further comprising two sets of lifting assembly disposed at both sides of the bearing framework, respectively, wherein each of the two sets of the lifting assembly comprises a first lifting rod and a second lifting rod, one end of the first lifting rod and one end of the second lifting rod are rotatably connected to the corresponding front bearing plate, the other end of the first lifting rod and the other end of the second lifting rod are rotatably connected to the pedestal; and/or, the chair frame further comprises a waist support assembly, the waist support assembly comprises a second push rod, a waist support synchronizing rod and two waist support plates, two ends of the second push rod are pivotably connected to the waist support synchronizing rod and the connecting rod fixed to the front bearing plate, the two waist support plates are rotatably connected to the two back bearing plates disposed at both sides of the chair frame, respectively, and both ends of the waist support synchronizing rod are connected to the two waist support plates, respectively.
